(19) United States
(12) Patent Application Publication
(10) Pub. No.: US 2025/0005608 A1
(43) Pub. Date: Jan. 2, 2025

(54) CUSTOMER VALUE FORECASTING

(71) Applicant: NCR Voyix Corporation, Atlanta, GA (US)

(72) Inventors: Thomas Philip Murray, New York, NY (US); Pavan Kumar Vattyam, Atlanta, GA (US); Kyle Alexander King, Bogart, GA (US); Chase Tyler Nicholson, Atlanta, GA (US); Norman Leonard Trujillo, Frisco, TX (US); Kun Zhu, Smyrna, GA (US)

(21) Appl. No.: 18/217,217

(22) Filed: Jun. 30, 2023

(51) Int. Cl. G06Q 30/0202

(52) U.S. Cl. CPC G06Q 30/0202

(57) ABSTRACT

One or more machine learning models are trained on financial institution (FI) specific customer and enterprise data to predict future transactions, churn likelihood, and a customer lifetime value (CLV) per customer of the FI over a given period of future time. In an embodiment, the CLV for the given period of future time is calculated and predicted using statistical and/or heuristic analysis based on predicted transactions provided by one or more models. The predicted transactions, churn likelihood, and CLV are provided through an Application Programming Interface (API) for integration into systems of the FI and/or accessible through a web-based interface and/or mobile application interface to users of the FI.

### BACKGROUND

Enterprises struggle with determining how valuable their customers are to the enterprises. With limited resources, an enterprise wants to properly allocate incentives to those customers providing the most value to the enterprise and to those customers showing potential to be of value to the enterprise. Furthermore, an enterprise does not what to waste limited resources on those customers that are likely never going to be of any significant value to the enterprise or waste resource on customers who are going to leave the enterprise no matter how much the enterprise invests in retaining those customers.

Existing technologies provide customer value predictions, however, these technologies are not customized for a type of enterprise and as a result are often of little meaningful value to certain types of enterprises. For example, a financial institution have customers that should be evaluated differently from a generic enterprise.

### SUMMARY

In various embodiments, a system and methods for customer value forecasting are presented. One or more machine learning models (“models” and/or “MLM”) are trained on historical customer data and enterprise data of a financial institution (FI) to predict further transactions, churn likelihood, and a customer lifetime value (CLV) per customer over a given period or interval of future time. The predicted data is provided to the FI through an application programming interface (API) to systems of the FI and/or provided through the API to a web-based and/or mobile application interface.

### BRIEF DESCRIPTION OF THE DRAWINGS

FIG. 1 is a diagram of a system for customer value forecasting, according to an example embodiment.

FIG. 2 is a flow diagram of a method for customer value forecasting, according to an example embodiment.

FIG. 3 is a flow diagram of another method for customer value forecasting, according to an example embodiment.

### DETAILED DESCRIPTION

Existing customer value technologies are generic and not customized to the unique circumstances of a particular type of industry. One such technology is often referred to as the “Buy Till You Die” (BTYD) statistical framework. The BTYD statistical framework is commonly used in retail to predict a customer lifetime value (CLV) for a customer of an enterprise. There are multiple variants of the BTYD models, but they generally assume that each customer as a distinct transaction rate that follows a certain statistical distribution and population-level behavior of the transaction rate.

CLV is a valuable tool for financial institutions (FIs) to inform their marketing and customer acquisition strategies. CLV advises the FI in leveraging the most cost-effective methods of acquiring customers based on the return on investment (ROI) through marketing campaigns. By understanding the value to their business and customer base, FIs can make data-driven decisions to optimize their marketing efforts and maximize the value of their customer relationships.

However, financial institutions (FIs) experience different statistical models and factors with their customers which are more relevant in determining a given CLV for a given customer from that which is currently available through existing BTYD approaches. FI customers generate profit for the FI in a variety of ways, such as interchange fees from debit/credit transactions, interest from loans, insufficient fund fees, service charges, and high savings account balances. FI customers also generate costs for the FI in manage ways; for example, costs associated with using specific channels, such as Automated Teller Machine (ATM) customer usage, branch usage, online or digital usage, etc. Every FI customer engages with produces of the FI at varying and disparate rates. Customers can churn at any time, without notifying the bank (non-contractual business setting) as customers are free to withdraw their funds at any time. Furthermore, churn is virtually unobservable even in historical data. For example, when a customer stops using a bank's products, it is difficult to know exactly when the relationship between the bank and the customer truly ended.

There are important distinctions between predicting CLV in a general retail setting versus a FI setting. To derive CLV in retail, the number of predicted transactions from a given BTYD model is multiplied by the average price of each customer's transaction, which usually comes from another statistical model. However, in banking, multiple sources of revenue and costs with different generation processes have to be accounted for and modeled separately. For example, direct and indirect customers of FIs behave very differently from generic retail customers. Debit/Credit transactions need to have their own BTYD model and any predicted future transaction must be multiplied with a corresponding interchange fee. Insufficient fund violations need a separate BTYD model, and the predicted number of future insufficient fund violations must be multiplied in the corresponding insufficient fund fee. High deposit balances are valuable to a bank because they can leverage these balances to loan money to their customers without borrowing money from the federal reserve. The value of these balances requires better quantification for any BTYD model. Profit from other fees (e.g. external funds transfer fees, non-sufficient fund fees, etc.), and channel costs require specialized modeling for the BTYD or for a specialized forecasting model. Loans fall into the setting of contractual business and should not be modeled with existing BTYD approaches, rather, the profitability should be estimated for a loan of a given interest rate and given loan terms.

The techniques provided herein and below address these issues faced by FIs by accurately forecasting CLVs accounting for the unique circumstances of FIs and their customers. Machine learning models (hereinafter “models” and/or “MLMs) are provided that accounts or banking-specific phenomena or factors in predicting future transactions per customer. Individual-level customer transaction rates are calculated by maximizing the likelihood of observing specific parameters identified from historical customer data and historical enterprise data. Once this is established, predictions about a total number of future transactions on an individual level and a probability that a given customer has already churned are calculated and provided. The predicted transactions, predicted churn, and other factors are used to calculate a CLV per customer. The customer predicted CLVs are integrated into systems of the FIs via an Application Programming Interface (API). In an embodiment, the predicted transactions, predicted churn, and other factors are provided as detailed information to the FIs about their customers.

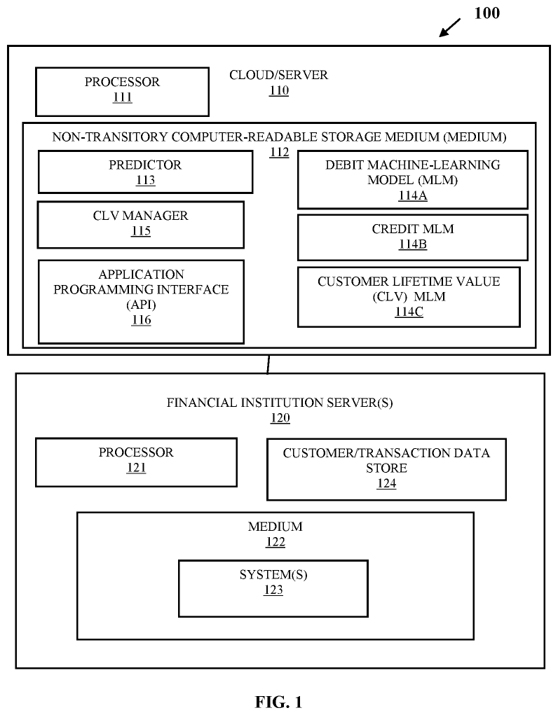

Within this initial context, various embodiments are now presented with reference to FIG. FIG. 1 is a diagram of a system 100 for customer value forecasting, according to an example embodiment. It is to be noted that the components are shown schematically in greatly simplified form, with only those components relevant to understanding of the embodiments being illustrated.

Furthermore, the various components illustrated in FIG. 1 and their arrangement is presented for purposes of illustration only. It is to be noted that other arrangements with more or less components are possible without departing from the teachings of customer value forecasting as presented herein and below.

The system 100 includes a cloud 110 or a server 110 (herein after just “cloud 110”) and a plurality of FI servers 120. Cloud 110 includes a processor 111 and a non-transitory computer-readable storage medium (herein after just “medium”) 112, which includes executable instructions for a predictor 113, a debit model 114A, a credit model 114B, a CLV model 114C, a CLV manager 115, and an API 116. The instructions when executed by processor 111 perform operations discussed herein and below with respect to 113, 114A, 114B, 114C, 115, and 116.

Each FI server 120 includes a processor 121 and medium 112, which includes executable instructions for systems 123. The instructions when executed by processor 121 perform operations discussed herein and below with respect to systems 123. Each FI server 120 further includes a customer/transaction data store 124. The customer/transaction data store 124 includes data for customer identifiers, customer transactions, type of transactions (e.g., credit, debit, loan), data and time of day for each transaction, location and device associated with each transaction, loan types, loan terms, customer creation date, insufficient fund violations, deposit balance by data and time, channel costs, profit per transaction, interchange fees, customer age, customer fees, customer accounts, customer financial service products, etc.

Initially, models 114A and 114B are trained on labeled parameter data that identifies factors relevant to predicting future transactions for a given customer's transaction history. The historical transaction data is obtained from a given FI server 120 over a past period of time and labeled. By way of example only, the input parameters, per customer, include customer identifier, transaction date, transaction time, transaction location, transaction device (ATM, user device, teller device, etc.), insufficient fund violations, interchange fees, costs of a given transaction, profit of a given transaction, loans if any, loan terms, loan interest, loan origination date, etc.

Model 114A is trained to output a total predicted number of debit-based transactions for a given future period or interval of time per customer and a predicted customer churn value during the future interval of time. The predicted customer churn value is a scalar value representing a percentage from 0 to 100, the percentage is the likelihood that the customer during the given future period or interval of time will leave the FI as a customer. Training includes frequency and recency of transactions for a given customer during the interval or time from the historical data being used for training. The frequency and recency of the transaction are used as a basis for predicting the transactions or transaction rate in the given future period or interval of time. The Model 114B is similarly trained on the historical data for the historical interval or period of time on a per customer basis. Model 114B unlike Model 114A utilized credit card transactions and predicts credit-based transactions for the given future period or interval of time per customer and a predicted customer churn value.

CLV model 114C is trained to take as input a variety of labeled parameter data for purposes of predicting, per customer, a CLV of the corresponding customer from the perspective of a given FI institution. By way of example only, the input labeled parameter data includes the predicted debit-based transactions and the predicted churn value outputted by the debit MLM 114A, the predicted credit-based transactions and the predicted churn value outputted by the credit MLM 114, a preassigned value on any savings account the corresponding customer has with the FI, a profile per interchange fee (e.g., credit transaction), a cost experienced by the FI for a given transaction type, profile from interest on any loan, etc. the CLV model 114C is trained on historically observed data with respect to customers viewed as high value, low value, and medium value. The preassigned value on the savings account is similarly assigned a high value, a low value, and a medium value based on an assessment provided by the corresponding FI for their savings account balances.

Once models 114A-114C are trained, predictor 113 is configured to periodically process the models 114A-114C at a given interval of time to obtain updated predicted debit and credit transactions, updated predicted churn values, and updated CLVs per customer of a given FI. For example, predictor 113 processes the models 114A-114C daily, weekly, bi-weekly, monthly, bi-monthly, quarterly, etc. During each iteration, the historical data for the past predicted interval, which has past, is updated with the actual observed transaction data.

In an embodiment, CLV manager 115 is a statistical and heuristic based algorithm that utilizes the predicted transactions and predicted churns from models 114A and 114B to calculate a CLV per customer for each future interval of time or period. In this embodiment, the CLV model 114C can be eliminated. In an embodiment, outputted predicted CLVs from the CLV model 114C is used as input to the CLV manager along with the predicted transactions and predicted churns of models 114B and 114C to determine and calculate a final adjusted CLV per customer within a given future period or interval of time.

Predictor 113 provides the predicted debit and credit transactions, the predicted churns, and the predicted CLV for each customer each time predictor 113 processes models 114A, 114B, and/or 114C. Predictor 113 can organize the output as records per customer and include in the record estimated total profit and total costs for both the predicted debit transactions and the predicted credit transactions. Each record represents the predictions, costs, profit, and CLV per customer for the current interval or time or period being projected for the FI.

API 116 provides the records to systems 123 of the FI for viewing. In an embodiment, a software-as-a-service (SaaS) is integrated into at least once system, such that the records are viewable via a dashboard interface integrated within the corresponding system. In an embodiment, a web-based and/or a mobile application-based interface is provided that uses API 116 to provide varying degrees of details for the customer records to the FI.

In an embodiment, more than the above-referenced models 114A-114C are trained on the FI-specific customer and enterprise data to predict transactions, churn, and CLV per customer over a given period of future time. In an embodiment, fewer or 1 single model are/is trained on the FI-specific customer and enterprise data to predict transactions, churn, and CLV per customer over a given period of future time.

In an embodiment, the CLV value calculated does not have to rely on the likelihood of churn; rather the predicted number of future transactions when low already correlates to a higher likelihood of churn. Thus, the likelihood of churn can be inferred when a mode or module 114B determines the CLV based at least on the predicted number of debit transactions and the predicted number of credit transactions.

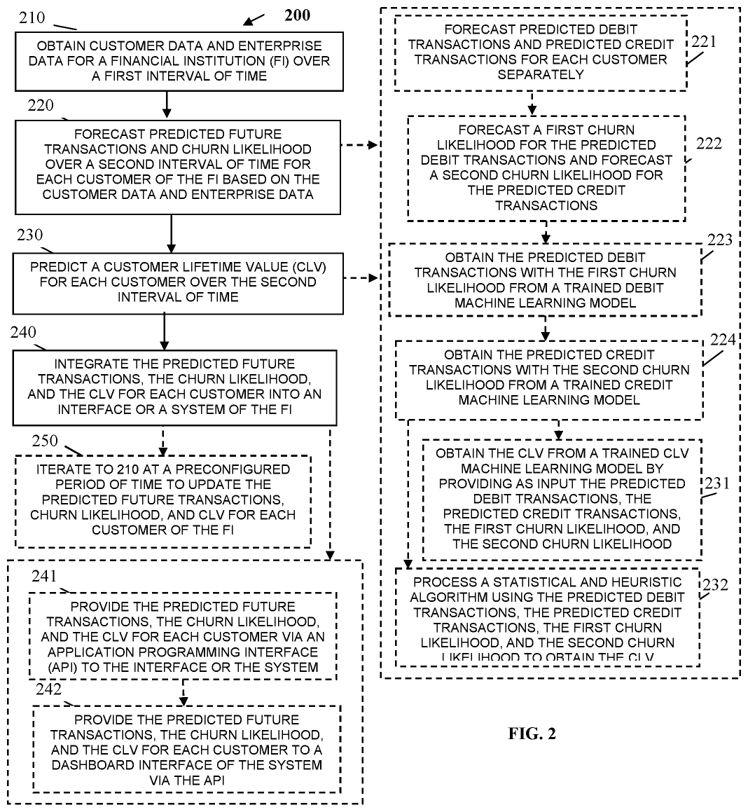

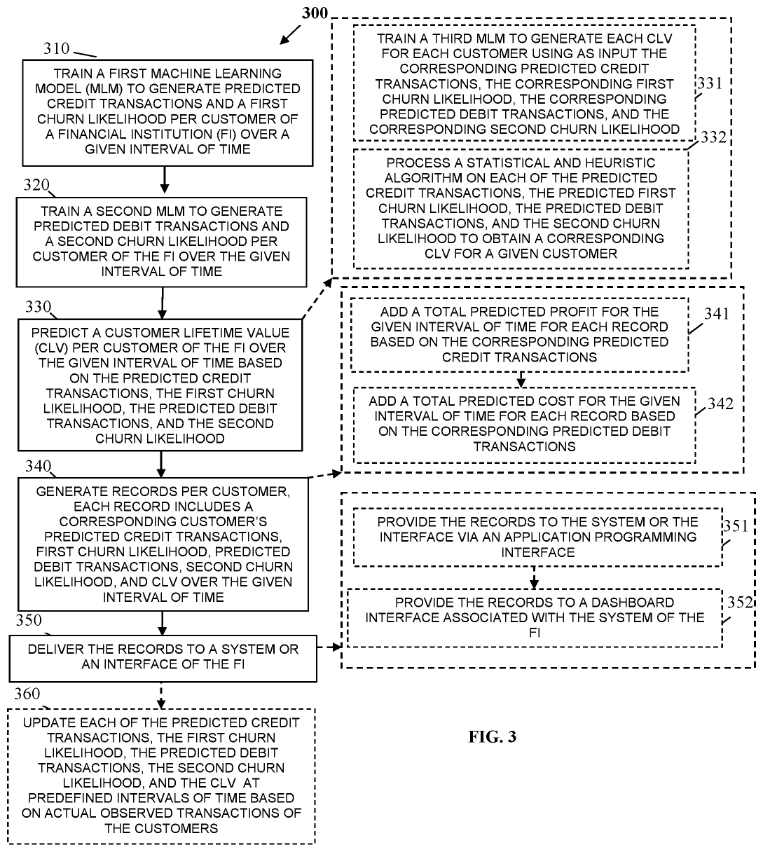

One now appreciates how FI-specific customer data and enterprise data is processed to accurately access a given customer's value to a FI. This accounts for the unique nature of FI products, government regulations, and business operations and does not rely upon a generic BTYD model as heretofore has been the case. These embodiments and other embodiments are now discussed with reference to FIGS. 2 and 3.

FIG. 2 is a flow diagram of a method 200 for customer value forecasting, according to an example embodiment. The software module(s) that implements the method 200 is referred to as a “customer value predictor.” The customer value predictor is implemented as executable instructions programmed and residing within memory and/or a non-transitory computer-readable (processor-readable) storage medium and executed by one or more processors of one or more devices. The processor(s) of the device(s) that executes the customer value predictor are specifically configured and programmed to process the customer value predictor. The customer value predictor has access to one or more network connections during its processing. The connections can be wired, wireless, or a combination of wired and wireless.

In an embodiment, the device that executes the customer value predictor is cloud 110 or server 110. In an embodiment, server 110 is a server of a given FI server 120 that manages branches. In an embodiment, the customer value predictor is some, all, or any combination of, predictor 113, 114A, 114B, 114C, 115, and/or 116.

At 210, customer value predictor obtains customer data and enterprise data for a FI over a first interval of time or historical period of time. At 220, the customer value predictor forecasts predicted further transactions and churn likelihood over a second interval of time for each customer of the FI based on the customer data and the enterprise data.

In an embodiment, at 221, the customer value predictor forecasts predicted debit transactions and predicted credit transactions for each customer separately. In an embodiment of 221, at 222, the customer value predictor forecasts a first churn likelihood for the predicted debit transaction and forecasts a second churn likelihood for the predicted credit transactions.

In an embodiment of 222 and at 223, the customer value predictor obtains the predicted debit transactions with the first churn likelihood from a trained debit model 114A. In an embodiment of 223 and at 224, the customer value predictor obtains the predicted credit transactions with the second churn likelihood from a trained credit model 114B.

At 230, the customer value predictor predicts a CLV for each customer over the second interval of time. In an embodiment of 224 and 230, at 231, the customer value predictor obtains the CLV from a trained CLV model 114C by providing as input the predicted debit transactions, the predicted credit transactions, the first churn likelihood, and the second churn likelihood. In an embodiment of 224 and 230, at 232, the customer value predictor processes a statistical and heuristic algorithm using the predicted debit transactions, the predicted debit transactions, the first churn likelihood, and the second churn likelihood.

At 240, the customer value predictor integrates the predicted further transactions, the churn likelihood, and the CLV for each customer into an interface or system 123 of the FI via FI server 120. In an embodiment, at 241, the customer value predictor provides the predicted future transactions, the churn likelihood, and the CLV for each customer via an API 116 to the interface of the system 123. In an embodiment of 241 and at 242, the customer value predictor provides the predicted future transactions, the churn likelihood, and the CLV for each customer to a dashboard interface of the system 123.

In an embodiment, at 250, the customer value predictor iterates to 210 at a preconfigured period of time to update the predicted future transactions, the churn likelihood, and the CLV for each customer of the FI. It is noted that the second interval of time does not have to be the same as the preconfigured period of time. Moreover, the first or a past interval or period of time, the preconfigured period of time, and the second interval of time can all be different intervals of time. For example, the second interval of future time can be for a month whereas the preconfigured period of time is daily, and the first interval of time is 6 months worth of past historical data. In this example, every day (i.e., predefined period of time) the projection for a next month (i.e., the second interval of time) is calculate using the most recent historical 6 month's (i.e., first or past period of time) worth of historical data.

FIG. 3 is a flow diagram of a method 300 for customer value forecasting, according to an example embodiment. The software module(s) that implements the method 300 is referred to as a “customer value predictor manager.” The customer value predictor manager is implemented as executable instructions programmed and residing within memory and/or a non-transitory computer-readable (processor-readable) storage medium and executed by one or more processors of one or more devices. The processor(s) of the device(s) that executes the customer value predictor manager are specifically configured and programmed to process the customer value predictor manager. The customer value predictor manager has access to one or more network connections during its processing. The connections can be wired, wireless, or a combination of wired and wireless.

In an embodiment, the device that executes the customer value predictor manager is cloud 110 or server 110. In an embodiment, the devices that executes the customer value predictor manager is a given FI server 120. In an embodiment, the customer value predictor manager is some, all, or any combination of, predictor 113, 114A, 114B, 114C, 115, 116, and/or method 200. In an embodiment, the customer value predictor manager presents another, and in some ways, an enhanced processing perspective to that which was discussed above with method 200 of FIG. 2.

At 310, customer value predictor manager trains a first model 114B to generate predicted credit transactions and a first churn likelihood per customer of a FI over a given interval of time (i.e., time projected into the future which has not yet arrived). This was discussed above with respect to credit model 114B in the discussion of FIG. 1.

At 320, the customer value predictor manager trains a second model 114A to generate predicted debit transactions and a second churn likelihood per customer of the FI over the given interval of time. This was discussed above with respect to debit model 114A in the discussion of FIG. 1.

At 330, the customer value predictor manager predicts a CLV per customer of the FI over the given interval of time based on the predicted credit transactions, the first churn likelihood, the predicted debit transactions, and the second churn likelihood. It is to be noted that other factors besides output from the first model 114B and the second model 114A are used in some embodiments; for example, a rating value assigned to a savings account balance by the FI for a given customer. The savings account rating values, in an embodiment, include low value, medium value, and high value.

In an embodiment, at 331, the customer value predictor manager trains a third model 114C to generate each CLV for each customer using as input the corresponding predicted credit transactions, the corresponding first churn likelihood, the corresponding predicted debit transactions, and the corresponding second churn likelihood. In an embodiment, at 332, the customer value predictor manager processes a statistical and heuristic algorithm, such as CLV manager 115, on each of the predicted credit transactions, the predicted first churn likelihood, the predicted debit transactions, and the predicted second churn likelihood to obtain a corresponding CLV for a given customer. In an embodiment, the customer value predictor manager obtains the CLV based on processing a combination of CLV model 114C and CLV manager 115.

At 340, the customer value predictor manager generates records per customer. Each record includes a corresponding customer's predicted credit transactions, the first churn likelihood, the predicted debit transactions, the second churn likelihood, and CLV over the given interval of time.

In an embodiment, at 341, the customer value predictor manager adds a total predicted profit for the given interval of time for each record based on the corresponding predicted credit transaction and a predetermined interchange fee charged by the FI for credit transactions. In an embodiment of 341 and at 342, the customer value predictor manager adds a total predicted cost for the given interval of time for each record based on the corresponding predicted debit transactions and predefined costs incurred by the FI for the debit transaction by channel (e.g., ATM, teller, online or digital, etc.).

At 350, the customer value predictor manager delivers the records to a system 123 or an interface of the FI. In an embodiment, at 351, the customer value predictor manager provides the records to the system 123 or the interface via an API 116. In an embodiment of 351 and at 352, the customer value predictor manager provides the records to a dashboard interface associated with the system 123 of the FI.

In an embodiment, at 360, the customer value predictor manager updates each of the predicted credit transactions, the first churn likelihood, the predicted debit transactions, the second churn likelihood, and the CLV at predefined intervals of time based on actual observed transactions of the customers. Again, the predefined intervals of time can differ from the given interval of time for which the predictions are being provided.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining customer data and enterprise data for a financial institution (FI) over a first interval of time;
forecasting predicted future transactions and churn likelihood over a second interval of time for each customer of the FI based on the customer data and the enterprise data;
predicting a customer lifetime value (CLV) for each customer over the second interval of time; and
integrating the predicted future transactions, the churn likelihood, and the CLV for each customer into an interface or a system of the FI.

2. The method of claim 1 further comprising:
iterating to the obtaining at a preconfigured period of time to update each of the predicted future transactions, churn likelihood, and CLV for each customer of the FI.

3. The method of claim 1, wherein forecasting further includes forecasting predicted debit transactions and predicted credit transactions for each customer separately.

4. The method of claim 3, wherein forecasting further includes forecasting a first churn likelihood for the predicted debit transactions and forecasting a second churn likelihood for the predicted credit transactions.

5. The method of claim 4, wherein forecasting further includes obtaining the predicted debit transactions with the first churn likelihood from a trained debit machine learning model.

6. The method of claim 5, wherein forecasting further includes obtaining the predicted credit transactions with the second churn likelihood from a trained credit machine learning model.

7. The method of claim 6, wherein predicting further includes obtaining the CLV from a trained CLV machine learning model by providing as input the predicted debit transactions, the predicted credit transactions, the first churn likelihood, and the second churn likelihood.

8. The method of claim 6, wherein predicting further includes processing a statistical and heuristic algorithm using the predicted debit transactions, the predicted credit transactions, the first churn likelihood, and the second churn likelihood to obtain the CLV.

9. The method of claim 1, wherein integrating further includes providing the predicted future transactions, the churn likelihood, and the CLV for each customer via an application programming interface (API) to the interface or the system.

10. The method of claim 9, wherein providing further includes providing the predicted future transactions, the churn likelihood, and the CLV for each customer to a dashboard interface of the system via the API.

11. A method, comprising:
training a first machine learning model (MLM) to generate predicted credit transactions and a first churn likelihood per customer of a financial institution (FI) over a given interval of time;
training a second MLM to generate predicted debit transactions and a second churn likelihood per customer of the FI over the given interval of time;
predicting a customer lifetime value (CLV) per customer of the FI over the given interval of time based on the predicted credit transactions, the first churn likelihood, the predicted debit transactions, and the second churn likelihood;
generating records per customer, each record includes a corresponding customer's predicted credit transactions, first churn likelihood, predicted debit transactions, second churn likelihood, and CLV over the given interval of time; and
delivering the records to a system or an interface of the FI.

12. The method of claim 11 further comprising:
updating each of the predicted credit transactions, the first churn likelihood, the second predicted credit transactions, the second churn likelihood, and the CLV at predefined intervals of time based on actual observed transactions of the customers.

13. The method of claim 11, wherein predicting further includes training a third MLM to generate each CLV for each customer using as input the corresponding predicted credit transactions, the corresponding first churn likelihood, the corresponding predicted debit transactions, and the corresponding second churn likelihood.

14. The method of claim 11, wherein predicting further includes processing a statistical and heuristic algorithm on each of the predicted credit transactions, the predicted first churn likelihood, the predicted debit transactions, and the second churn likelihood to obtain a corresponding CLV for a given customer.

15. The method of claim 11, wherein generating further includes adding a total predicted profit for the given interval of time for each record based on the corresponding predicted credit transactions.

16. The method of claim 15, wherein generating further includes adding a total predicted cost for the given interval of time for each record based on the corresponding predicted debit transactions.

17. The method of claim 11, wherein delivering further includes providing the records to the system or the interface via an application programming interface.

18. The method of claim 17, wherein providing further includes providing the records to a dashboard interface associated with a system of the FI.

19. A system, comprising:
at least one server comprising at least one processor and a non-transitory computer-readable storage medium;
the non-transitory computer-readable storage medium comprising executable instructions; and
the executable instructions when executed by at least one processor cause the at least one processor to perform operations, comprising:
obtaining customer data and enterprise data from a financial institution (FI) server associated with a FI;
forecasting predicted credit transactions and a first churn likelihood of each customer over a given interval of time based on the customer data and the enterprise data;
forecasting predicted debit transactions and a second churn likelihood of each customer over the given interval of time based on the customer data and the enterprise data;
predicting a customer lifetime value (CLV) of each customer over the given interval of time based on the customer data, the enterprise data, the predicted credit transactions, the first churn likelihood, the predicted debit transactions, and the second churn likelihood;
generating records per customer, each record includes a corresponding customer's predicted credit transactions, first churn likelihood, predicted debit transaction, second churn likelihood, and CLV for the given interval of time;
integrating the records into a system or an interface of the FI using an application programming interface.

20. The system of claim 19, wherein the operations associated with predicting the CLV further includes predicting the CLV of each customer based on a savings account balance associated with the corresponding customer.
